(19) United States
(12) Patent Application Publication
(10) Pub. No.: US 2026/0156448 A1
(43) Pub. Date: Jun. 4, 2026

(54) COMMUNICATION DEVICE WITH COST-EFFECTIVE STANDALONE SCANNING RADIO

(71) Applicant: MEDIATEK INC., Hsinchu City (TW)

(72) Inventors: Shu-Yuan Chang, Hsinchu City (TW); Sheng-Wen Hsu, Hsinchu City (TW)

(73) Assignee: MEDIATEK INC., Hsinchu City (TW)

(21) Appl. No.: 19/176,136

(22) Filed: Apr. 10, 2025

Related U.S. Application Data
(60) Provisional application No. 63/727,676, filed on Dec. 4, 2024.

(51) Int. Cl. H04W 8/00; H04B 17/309; H04B 17/318

(52) U.S. Cl. CPC H04W 8/005; H04B 17/318; H04B 17/346

(57) ABSTRACT

A communication device includes a processor, a primary radio device, a scanning radio device and a memory device. The primary radio device provides a wireless communication service to one or more client devices in a radio frequency (RF) environment and manages the wireless communication service in compliance with a predetermined wireless network protocol. The scanning radio device scans a plurality of channels in one or more frequency bands provided in the RF environment in compliance with the predetermined wireless network protocol. The memory device stores calibration data associated with the channels. The predetermined wireless network protocol is a Wi-Fi protocol. The primary radio device is a Wi-Fi access point chipset and the scanning radio device is a Wi-Fi client chipset.

### CROSS REFERENCE TO RELATED APPLICATIONS

This application claims the benefit of U.S. Provisional Application No. 63/727,676, filed on Dec. 4, 2024. The content of the application is incorporated herein by reference.

### BACKGROUND

Enterprise Access Points (EAPs) are designed to meet the demanding needs of large-scale environments such as offices, malls, hospitals, and schools. Unlike home Access Points (APs), EAPs support a higher number of simultaneous connections, offer wider coverage, and deliver faster data speeds. They come equipped with advanced features like automatic channel selection, load balancing, and seamless roaming, ensuring a stable and efficient network experience.

EAPs also provide robust security measures, including guest network isolation, portal authentication, and stronger encryption methods, which are crucial for protecting sensitive data in enterprise settings.

While EAPs are more expensive due to their superior performance and advanced capabilities, they are essential for environments that require high-density, reliable network coverage.

### SUMMARY

According to an embodiment of the invention, a communication device comprises a processor, a primary radio device, a scanning radio device and a memory device. The primary radio device provides a wireless communication service to one or more client devices in a radio frequency (RF) environment and manages the wireless communication service in compliance with a predetermined wireless network protocol. The scanning radio device scans a plurality of channels in one or more frequency bands provided in the RF environment in compliance with the predetermined wireless network protocol. The memory device stores calibration data associated with the channels. The predetermined wireless network protocol is a Wi-Fi protocol. The primary radio device is a Wi-Fi access point (AP) chipset and the scanning radio device is a Wi-Fi client chipset.

According to another embodiment of the invention, a communication device comprises a processor, a primary radio device, a scanning radio device and a memory device. The primary radio device provides a wireless communication service to one or more client devices in a radio frequency (RF) environment and manages the wireless communication service in compliance with a predetermined wireless network protocol. The scanning radio device scans a plurality of channels in one or more frequency bands provided in the RF environment in compliance with the predetermined wireless network protocol. The memory device stores calibration data associated with the channels. The predetermined wireless network protocol is a Wi-Fi protocol. The primary radio device is a Wi-Fi access point (AP) chipset and the scanning radio device is a Wi-Fi client chipset. When scanning the channels, the scanning radio device switches to one of the channels according to the calibration data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary block diagram of a communication device according to an embodiment of the invention.

FIG. 2 is an exemplary block diagram of a primary radio device according to an embodiment of the invention.

FIG. 3 is an exemplary block diagram of a scanning radio device according to an embodiment of the invention.

FIG. 4 is a schematic diagram showing the implementation of directly access according to an embodiment of the invention.

FIG. 5 is a schematic diagram showing the implementation of command-based access according to an embodiment of the invention.

FIG. 6 shows an exemplary message flow to complete a channel scanning procedure by directly accessing the memory according to an embodiment of the invention.

FIG. 7 shows an exemplary message flow to complete a channel scanning procedure by command-based accessing the memory according to an embodiment of the invention.

FIG. 8 is a schematic diagram showing the channel switch time required by runtime calibration and pre-calibration in the channel scanning procedure according to an embodiment of the invention.

FIG. 9 is a schematic diagram showing the achievable performance of the communication device with a standalone scanning radio to provide real-time RF monitoring and analysis services with lower hardware cost according to an embodiment of the invention.

### DETAILED DESCRIPTION

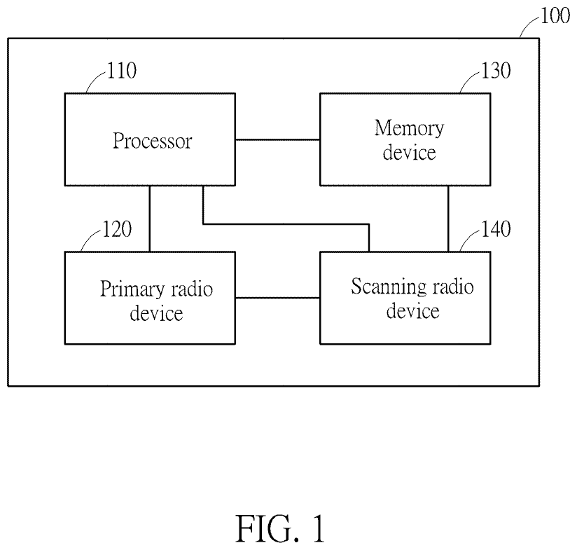

FIG. 1 is an exemplary block diagram of a communication device according to an embodiment of the invention. The communication device 100 may be an enterprise access point (EAP) device which, as compared to a general AP device or a home AP device, is capable of supporting a higher number of simultaneous connections, offering wider coverage, and delivering faster data speeds. The communication device 100 may at least comprise a processor 110, a primary radio device 120, a memory device 130 and a scanning radio device 140.

The primary radio device 120 is configured to provide a wireless communication service to one or more client devices in a radio frequency (RF) environment and manage the wireless communication service in compliance with a predetermined wireless network protocol. According to an embodiment of the invention, the predetermined wireless network protocol is one of Institute of Electrical and Electronics Engineers (IEEE) 802.11 series. For example, according to an embodiment of the invention, the predetermined wireless network protocol is the Wi-Fi protocol.

The scanning radio device 140 may act as a dedicated scanning radio device for the primary radio device 120 and configured to scan a plurality of channels in one or more frequency bands provided in the RF environment in compliance with the predetermined wireless network protocol.

In an embodiment of the invention, the primary radio device 120 and the scanning radio device 140 are both a Wi-Fi chipset and may be equipped with the same or substantially the same hardware specification, but the two Wi-Fi chipsets are different in that the primary radio device 120 is capable of providing Wi-Fi AP or EAP functionalities, such as connection management with services on the EAP device (e.g., the communication device 100), while the scanning radio device 140 is mainly configured to provide Wi-Fi client functionalities. In an embodiment of the invention, the primary radio device 120 is a Wi-Fi access point (AP) chipset and the scanning radio device is a Wi-Fi client chipset.

In addition, in the embodiments of the invention, the scanning radio device 140 is configured to scan the channels with different bandwidths in the frequency bands that are supported by the primary radio device 120, so as to monitor the channels for the primary radio device 120.

The processor 110 may be a central processing unit (CPU) or a microcontroller unit (MCU) of the communication device 100, and the memory device 130 is the internal memory device of the communication device 100. The processor 110 accesses the memory device 130 and controls the overall operations of the communication device 100, including the controls of the primary radio device 120 and the scanning radio device 140.

It should be noted that, in order to clarify the concept of the invention, FIG. 1 presents a simplified block diagram of a communication device in which only the components relevant to the invention are shown. As will be readily appreciated by a person of ordinary skill in the art, a communication device may further comprise other components not shown in FIG. 1 and configured for implementing the functions of wireless communication and related signal processing.

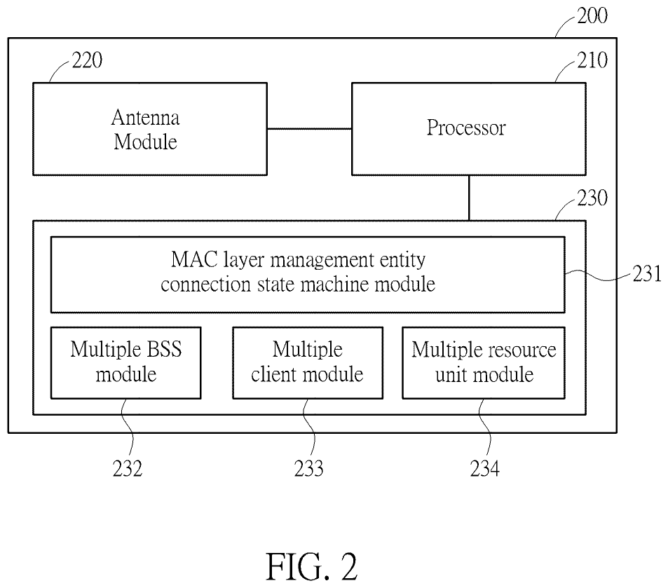

FIG. 2 is an exemplary block diagram of a primary radio device according to an embodiment of the invention. The primary radio device 200 may be the primary radio device 120 comprised in the communication device 100 and may at least comprise a processor 210, an antenna module 220 and a Medium Access Control (MAC) layer hardware module 230. The processor 210 is configured to provide the wireless communication service to the one or more client devices in the RF environment via the antenna module 220 and the MAC layer hardware module 230, and manage the wireless communication service. The antenna module 220 comprises one or more antennas for transmitting and receiving the RF signals in the RF environment. The MAC layer hardware module 230 comprises a MAC layer management entity connection state machine module 231, a multiple Basic Service Set (BSS) module 232, a multiple client module 233 and a multiple resource unit module 234.

The MAC layer management entity connection state machine module 231 is utilized to control the operations MAC layer management entity by the associated state machine.

The multiple BSS module 232 is configured to provide Multiple BSS related services. In Wi-Fi standards, the term Multiple BSS (MBSS) generally refers to the presence of multiple BSS within a single physical wireless network. Each BSS consists of an access point (AP) and its associated client devices. The MBSS allows the operation of multiple BSS within the same physical network to enhance network flexibility and capacity. The multiple BSS module 232 is configured to activate multiple BSS identifier (BSSID) sets to provide several Wi-Fi APs at one Wi-Fi AP device, e.g., the primary radio device 200. This Wi-Fi AP device is able to send out individual beacon or probe response frames for each BSSID set. As a result, for Wi-Fi client devices, several Wi-Fi APs can be scanned.

The multiple client module 233 is configured to provide multiple clients related services. The multiple client module 233 may record and maintain information associated with each connected Wi-Fi client device, including MAC address, Service Set Identifier (SSID), key, connection state, power saving sate, . . . etc.

The multiple resource unit module 234 is configured to provide resource unit related services. The multiple resource unit module 234 may allocate, dispatch and individually schedule physical radio resources to each connected Wi-Fi clients not only in time domain, but also in frequency domain (frequency tone), to provide higher utilization rate of physical radio resources between each connected Wi-Fi client at the same time.

It should be noted that, in order to clarify the concept of the invention, FIG. 2 presents a simplified block diagram of a radio device (e.g., a primary radio device) in which only the components relevant to the invention are shown. As will be readily appreciated by a person of ordinary skill in the art, a primary radio device or a Wi-Fi AP chipset may further comprise other components not shown in FIG. 2 and configured for implementing the functions of wireless communication managing and related signal processing.

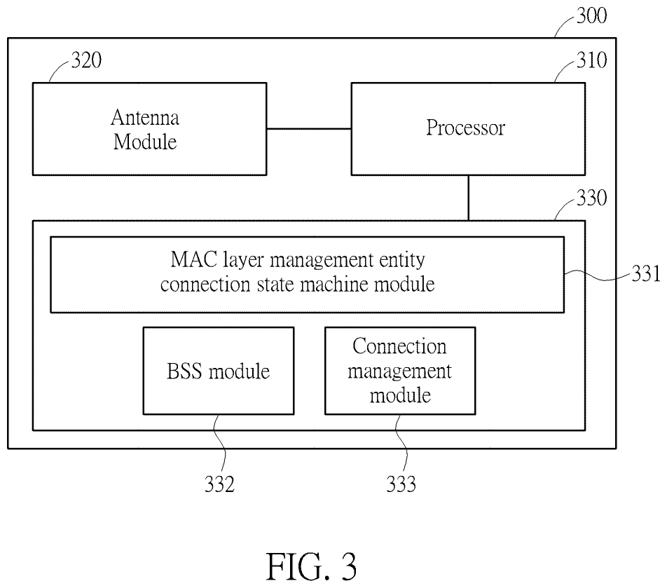

FIG. 3 is an exemplary block diagram of a scanning radio device according to an embodiment of the invention. The scanning radio device 300 may be the scanning radio device 140 comprised in the communication device 100. Similar to the primary radio device 200, the scanning radio device 300 may comprise a processor 310, an antenna module 320 and a MAC layer hardware module 330. The processor 310 is configured to manage wireless communication associated with a client device via the antenna module 320 and the MAC layer hardware module 330. The antenna module 320 comprises one or more antennas for transmitting and receiving the RF signals in the RF environment. The MAC layer hardware module 330 comprises a MAC layer management entity connection state machine module 331, a BSS module 332 and a connection management module 333.

It should be noted that, in order to clarify the concept of the invention, FIG. 3 presents a simplified block diagram of a radio device (e.g., a scanning radio device) in which only the components relevant to the invention are shown. As will be readily appreciated by a person of ordinary skill in the art, a scanning radio device or a Wi-Fi client chipset may further comprise other components not shown in FIG. 3 and configured for implementing the functions of wireless communication managing and related signal processing.

Similar to the MAC layer management entity connection state machine module 231, the MAC layer management entity connection state machine module 331 is utilized to control the operations MAC layer management entity. The BSS module 332 is configured to provide BSS related services. The connection management module 333 is configured to manage the connection for the client device.

In the embodiments of the invention, one difference between the multiple BSS module 232 and the BSS module 332 may be the number of BSS that can be activated or maintained. For example, in one embodiment of the invention, the number of BSS that can be activated or maintained by the multiple BSS module 232 may be ranged from 16 to 30, while the number of BSS that can be activated or maintained by the BSS module 332 may be only 1 or around 1 or 2.

In addition, in the embodiments of the invention, since functionalities and the capabilities of the primary radio device 120/200 and the scanning radio device 140/300 are different, the internal memory size of the primary radio device 120/200 and the internal memory size of the scanning radio device 140/300 are different as well. The scanning radio device 140 may have a relatively small internal memory size as compared to the primary radio device 120/200.

Therefore, in the embodiments of the invention, although the primary radio device 120/200 and the scanning radio device 140 may be both a Wi-Fi chipset, a hardware cost of the scanning radio device 140/300 is much lower than the primary radio device 120/200, and the scanning radio device 140/300 is utilized as a dedicated scanning radio device to achieve a cost-effective standalone scanning radio solution which provides real-time RF monitoring and analysis services with a low hardware cost.

In the embodiments of the invention, the scanning radio device 140/300 may be a Wi-Fi client radio hardware (e.g., a Wi-Fi client chipset) with associated software running thereon and having just-fit radio capabilities, while the primary radio device 120/200 may be a Wi-Fi AP radio hardware (e.g., a Wi-Fi AP chipset) with associated software running thereon and having much powerful radio capabilities. The Wi-Fi client chipset is typically adapted to consumer products, such as laptops, mobile phones, tablets, and TVs, to provide Wi-Fi client services which would find and establish wireless network via intranet or internet. Therefore, the scanning process for finding available wireless networks would be the primary service in Wi-Fi client chipset.

In the embodiments of the invention, the scanning radio device 140/300 may fine-tune the scanning process which requires quick switch channel time and possessing real-time calibration algorithms capabilities. Additionally, a Wi-Fi client chipset requires lower CPU power consumption than a Wi-Fi AP chipset because the Wi-Fi client chipset may only support handling data traffic with a single wireless device. As a result, the hardware cost of the scanning radio device 140/300 is much lower than the primary radio device 120/200. In this manner, an EAP device (e.g., the communication device 100) with cost-effective standalone scanning radio is achieved.

In addition, in the embodiments of the invention, the hardware cost of the scanning radio device 140/300 is further reduced by sharing the memory device 130 of the communication device 100 with the scanning radio device 140/300 to store the Wi-Fi radio required data that is required when scanning the channels.

For an EAP device (e.g., the communication device 100), the scanning is a critical and important feature to optimize the channel with bandwidth and radio band deployment results by continuously monitoring the wireless RF environment. With the wireless monitoring feature, the communication device 100 is able to adapt into changeable wireless radio conditions through various services, such as, channel utilization profiling with band steering, continuous spectrum analysis and wireless signal with network performance monitoring. In addition, with the wireless monitoring feature, intranet wireless security of the communication device 100 may also be enhanced through wireless intrusion detection with prevention system.

In the embodiments of the invention, the Wi-Fi radio required data stored in the shared memory device 130 may be accessed by two different ways, including the “directly access” and the “command-based access”.

For the case of “directly access”, the memory device 130 of the communication device 100 stores the Wi-Fi radio required data and the scanning radio device 140/300 is able to directly access the memory device 130 to obtain the Wi-Fi radio required data, thereby extending the storage size of the scanning radio device 140/300.

For the case of “command-based access”, the memory device 130 of the communication device 100 stores the Wi-Fi radio required data and the processor 110 accesses the memory device 130 to obtain the Wi-Fi radio required data and forwards the data to the scanning radio device 140/300 via various hardware interfaces (i.e., Universal Serial Bus (USB), Secure Digital Input/Output (SDIO), Peripheral Component Interconnect Express (PCIe) . . . etc.) with predefined firmware commands, thereby extending the storage size of the scanning radio device 140/300.

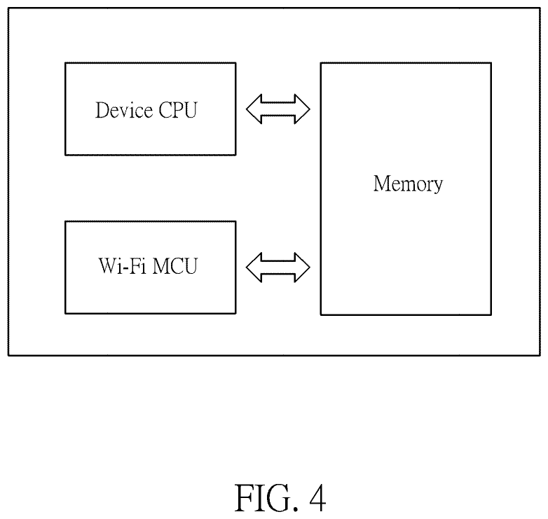

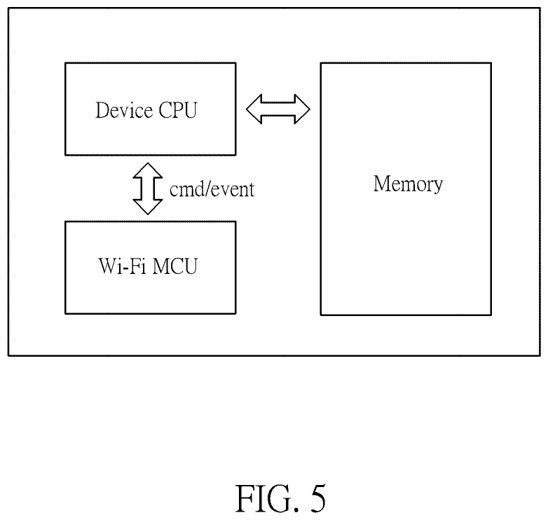

FIG. 4 is a schematic diagram showing the implementation of directly access according to an embodiment of the invention. FIG. 5 is a schematic diagram showing the implementation of command-based access according to an embodiment of the invention.

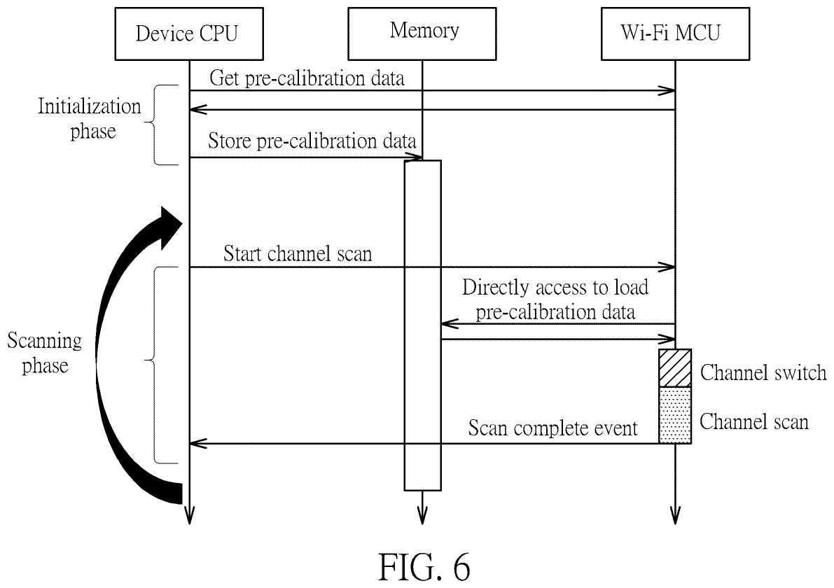

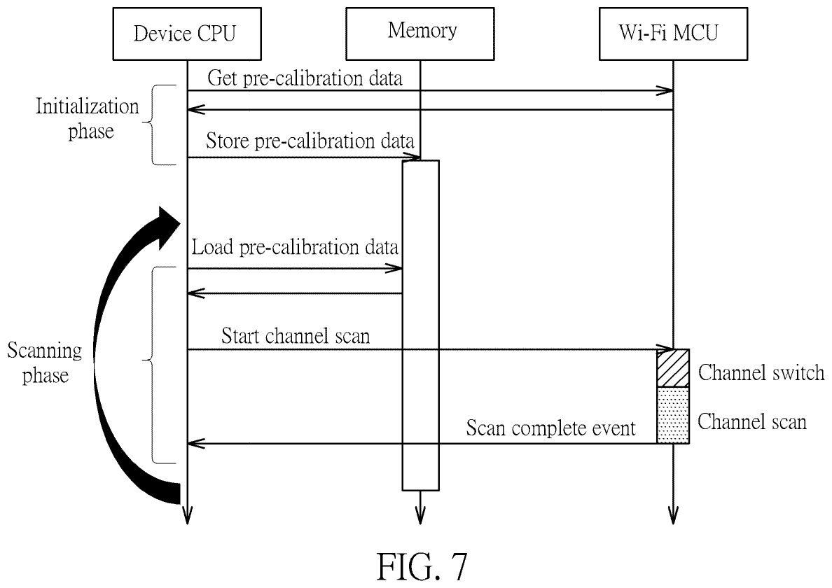

In the embodiments as shown in FIG. 4 and FIG. 5, the scanning radio device 140/300 is implemented by a Wi-Fi Client chipset. For simplicity and clarity, in FIG. 4 and FIG. 5, as well as in the subsequent FIG. 6 and FIG. 7, the “device CPU” is a representative of the processor 110 of the communication device 100, the “Wi-Fi MCU” is a representative of the processor of Wi-Fi Client chipset and the “memory” is a representative of the memory device 130 of the communication device 100.

As shown in FIG. 4, for the case of “directly access”, both the device CPU and the Wi-Fi MCU are able to directly access the memory.

As shown in FIG. 5, for the case of “command-based access”, only the device CPU is able to directly access the memory. The device CPU accesses the memory to obtain the Wi-Fi radio required data and forwards the data to the Wi-Fi MCU via a hardware interface with predefined firmware commands.

According to an embodiment of the invention, the Wi-Fi radio required data may comprise calibration data associated with the channels to be scanned by the scanning radio device 140/300. In the embodiments of the invention, the processor of the scanning radio device 140/300 (e.g., the processor 310) (hereinafter using the term “scanning radio device” or “Wi-Fi MCU” as a representative for brevity) performs a parameter calibration on one or more RF parameters for the channels to obtain the calibration data before scanning the channels, and stores the calibration data in the memory device (e.g., the memory device 130) of the communication device (e.g., the communication device 100) directly or through the processor (e.g., the processor 110) as the aforementioned two different ways for accessing the memory device. When scanning the channels, the scanning radio device switches to one of the channels according to the calibration data stored in the memory device.

According to the embodiments of the invention, the one or more RF parameters comprise a power parameter, a frequency parameter, an antenna parameter and a receiver sensitivity parameter.

In the embodiments of the invention, the scanning radio device is responsible for scanning and monitoring RF environment via off-channel operations, such transmitting, receiving, scanning, . . . etc. In the embodiments of the invention, the scanning radio device does not send beacon frames, does not provide a wireless communication service to any client device, does not maintain clients'connection parameters, and does not have to keep higher transmitter power capability . . . etc. However, the scanning radio device needs to do full RF calibration for supporting full-band with full-channel at different bandwidths.

In the embodiments of the invention, the scanning radio device is configured to collect radio and channel attributes. For example, when scanning the channels, the scanning radio device may further perform at least one of a plurality of operations comprising: determining a status of a channel utilization, determining a Received Signal Strength Indicator (RSSI) in a receiving direction, determining a noise level in the receiving direction, determining an RF spectrum, and determining channel state information associated with the channels.

In addition, in the embodiments of the invention, the scanning radio device is a standalone scanning radio, and the primary radio device (e.g., the primary radio device 120/200) and the scanning radio device are controlled independently to offer more accurate and consistent scanning and primary radio performance. Therefore, in the embodiments of the invention, the scanning radio device scans the channel while the primary radio device is providing the wireless communication service in the RF environment.

In the embodiments of the invention, the scanning radio device may further obtain one or more scanning results associated with the channels and provides the one or more scanning results to the processor of the communication device or the primary radio device.

For example, the scanning radio device may summarize the current wireless environment status based on the scanning results and provide a wireless channel assignment plan, fine-tune transmission power and receiver sensitivity of the primary radio device for better wireless network performance. The scanning radio device may also perform wireless environment analysis based on the scanning results and provide the analyzed result to the processor of the communication device or the primary radio device. Note that in other embodiments of the invention, the wireless environment analysis may also be performed by processor of the communication device or the primary radio device, or may be performed by a cloud server or a cloud processor, and the invention is not limited to any specific implementation.

In the embodiments of the invention, based on the obtained scanning results, the primary radio device or the processor of the communication device may further perform some subsequent tasks, for example but not limited to, monitoring and adjusting radio resource so as to optimize coverage and capacity of the primary radio device, increasing or decreasing transmit power in response to changes in the RF environment, dynamically allocating channel assignment to avoid conflict and to increase capacity and performance, detecting and correcting the areas of radio coverage in a wireless local area network that are below the level needed for robust radio performance, and grouping radio resources for coordination and network calculation. By performing one or more of the tasks, the performance of the wireless communication services provided by the primary radio device can be enhanced.

In addition, in the embodiments of the invention, the scanning radio device may further detect and de-authorize rouge AP in this wireless intranet network. Therefore, the scanning radio device may have two important capability indexes. One is to receive, decode and transmit all packets, all rates. The other is a reliable, quick, and efficient channel-switching performance under continuous channel switch operations.

FIG. 6 shows an exemplary message flow to complete a channel scanning procedure by directly accessing the memory according to an embodiment of the invention. The Wi-Fi MCU may perform parameter calibrations on one or more RF parameters for the channels to be scanned to obtain the calibration data (i.e., the pre-calibration data as shown).

In an initialization phase, the device CPU issues a command to the Wi-Fi MCU to get the pre-calibration data, and in response to the received command, the Wi-Fi MCU provides the pre-calibration data to the device CPU. The device CPU stores the pre-calibration data in the memory.

In a scanning phase, the device CPU issues a command to the Wi-Fi MCU to start a channel scan based on the pre-calibration data. The Wi-Fi MCU directly accesses the memory to obtain the pre-calibration data associated with a channel which is about to be scanned and load the pre-calibration data associated with the channel in its internal memory.

The Wi-Fi MCU performs channel switch to switch to the channel (which may include the operations of setup and activate RF radio and baseband attributes, and so on) based on the pre-calibration data associated with the channel, and performs channel scan to obtain one or more scanning results associated with the channel. When the channel scan is completed, the Wi-Fi MCU transmits a scan complete event to the device CPU, and the device CPU may trigger a next channel scan by issuing a next command to the Wi-Fi MCU to start a next channel scan based on the pre-calibration data.

Note that in some embodiments of the invention, the Wi-Fi MCU may also perform channel scans on a plurality of channels in response to one command received from the device CPU, and transmit the scan complete event to the device CPU when the channel scan on the channels are completed.

FIG. 7 shows an exemplary message flow to complete a channel scanning procedure by command-based accessing the memory according to an embodiment of the invention. The Wi-Fi MCU may perform parameter calibrations on one or more RF parameters for the channels to be scanned to obtain the calibration data (i.e., the pre-calibration data as shown).

In an initialization phase, the device CPU issues a command to the Wi-Fi MCU to get the pre-calibration data, and in response to the received command, the Wi-Fi MCU provides the pre-calibration data to the device CPU. The device CPU stores the pre-calibration data in the memory.

In a scanning phase, the device CPU loads the pre-calibration data associated with a channel to be scanned, forwards the pre-calibration data loaded from the memory and issues a command to the Wi-Fi MCU to start a channel scan based on the pre-calibration data.

The Wi-Fi MCU performs channel switch to switch to the channel (which may include the operations of setup and activate RF radio and baseband attributes, and so on) based on the pre-calibration data associated with the channel, and performs channel scan to obtain one or more scanning results associated with the channel. When the channel scan is completed, the Wi-Fi MCU transmits a scan complete event to the device CPU, and the device CPU further loads the pre-calibration data associated with a next channel to be scanned for the Wi-Fi MCU to start a next channel scan based on the pre-calibration data.

Note that in some embodiments of the invention, the Wi-Fi MCU may also perform channel scans on a plurality of channels in response to one command received from the device CPU, and transmit the scan complete event to the device CPU when the channel scan on the channels are completed.

Note further that in some embodiments of the invention, when the scanning phase is entered, the Wi-Fi MCU may also issue predefined firmware command at any time to trigger the device CPU to access the memory and load the pre-calibration data associated with a channel to be scanned.

Note further that in some embodiments of the invention, a priority tag may be added to each firmware command. The Wi-Fi MCU and device CPU may detect the priority tag from command header. If the priority of a command is the highest, the command is processed as soon as possible to further enhance the performance of the proposed command-based access.

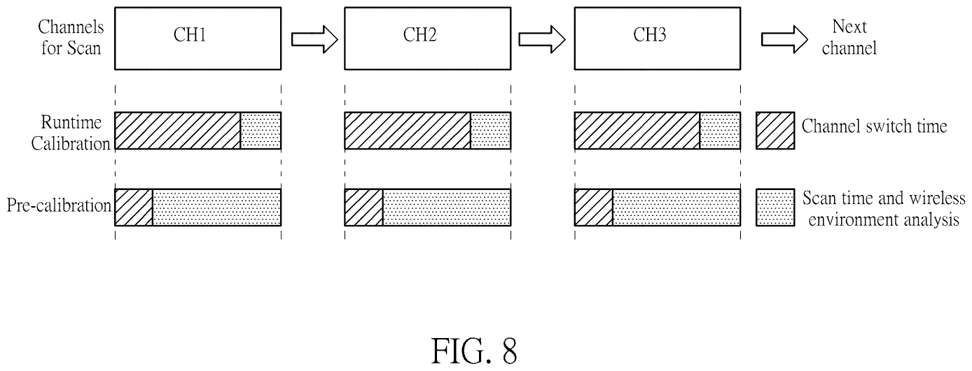

FIG. 8 is a schematic diagram showing the channel switch time required by runtime calibration and pre-calibration in the channel scanning procedure according to an embodiment of the invention.

For the runtime calibration, the RF parameters associated with a channel are runtime calibrated right before the channel scan operation. Therefore, it requires a significant amount of time to perform runtime calibration when switching to a new channel.

In the embodiments of the invention, scanning performance can be further enhanced by performing pre-calibration. That is, the Wi-Fi MCU performs the parameter calibration on one or more RF parameters for the channels to obtain the calibration data (i.e., the pre-calibration data) before scanning the channels. Therefore, as compared to the runtime calibration, the channel switch time is greatly reduced, and more time slot is left and obtained by the Wi-Fi MCU for the subsequent scanning process (including collecting wireless data such as RSSI, noise, peer MAC info, . . . etc.) and wireless environment analysis.

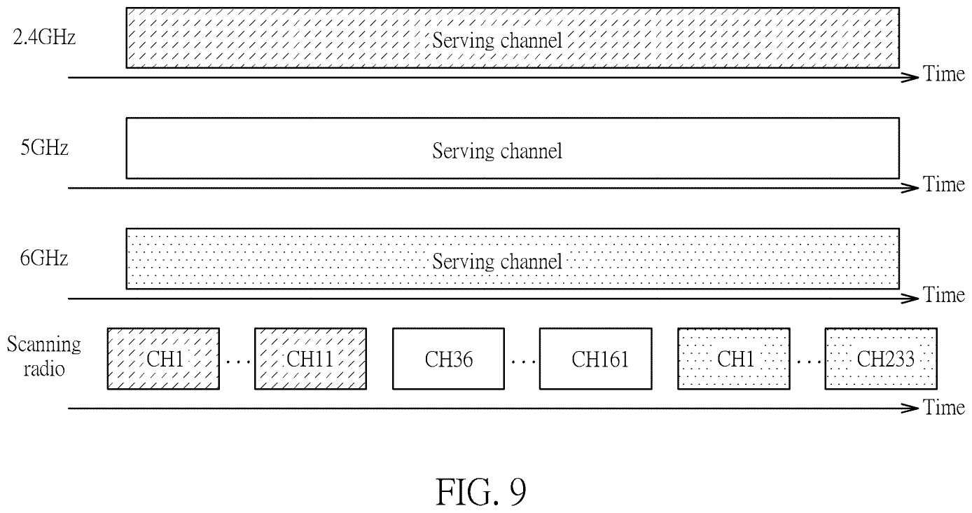

FIG. 9 is a schematic diagram showing the achievable performance of the communication device with a standalone scanning radio to provide real-time RF monitoring and analysis services with lower hardware cost according to an embodiment of the invention.

In FIG. 9, the serving channel operations on 2.4 GHz, 5 GHz and 6 GHz bands represent p the wireless communication services provided by the primary radio device (e.g., the primary radio device 120/200) on the 2.4 GHz, 5 GHz and 6 GHz bands, and the channel scan operations on the corresponding 2.4 GHz, 5 GHz and 6 GHz frequency bands of the scanning radio are shown in the bottom of FIG. 9.

In the embodiments of the invention, since the scanning radio device (e.g., the primary radio device 140/300) is a standalone scanning radio, and the primary radio device (e.g., the primary radio device 120/200) and the scanning radio device are controlled independently, the scanning radio device does not have to share the same hardware and software resources with the primary radio device, and therefore non-interrupted serving channel operations of the primary radio device on 2.4 GHz, 5 GHz and 6 GHz bands are achieved.

As shown in FIG. 9, the scanning radio device scans the channel while the primary radio device is providing the wireless communication service in the corresponding frequency bands. Therefore, primary radio performance of the primary radio device is maintained while more accurate and consistent scanning can be offered.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device, comprising:
a processor;
a primary radio device, providing a wireless communication service to one or more client devices in a radio frequency (RF) environment and managing the wireless communication service in compliance with a predetermined wireless network protocol;
a scanning radio device, scanning a plurality of channels in one or more frequency bands provided in the RF environment in compliance with the predetermined wireless network protocol; and
a memory device, storing calibration data associated with the plurality of channels;
wherein the predetermined wireless network protocol is a Wi-Fi protocol;
wherein the primary radio device is a Wi-Fi access point (AP) chipset and the scanning radio device is a Wi-Fi client chipset.

2. The communication device of claim 1, wherein when scanning the plurality of channels, the scanning radio device switches to one of the plurality of channels according to the calibration data stored in the memory device.

3. The communication device of claim 1, wherein when scanning the plurality of channels, the scanning radio device performs at least one of a plurality of operations comprising: determining a status of a channel utilization, determining a Received Signal Strength Indicator (RSSI) in a receiving direction, determining a noise level in the receiving direction, determining an RF spectrum, and determining channel state information associated with the plurality of channels.

4. The communication device of claim 1, wherein the scanning radio device further obtains one or more scanning results associated with the plurality of channels, and provides the one or more scanning results to the processor or the primary radio device.

5. The communication device of claim 1, wherein the scanning radio device directly accesses the memory device to obtain the calibration data.

6. The communication device of claim 1, wherein the processor accesses the memory device to obtain the calibration data and forwards the calibration data to the scanning radio device.

7. The communication device of claim 1, wherein the scanning radio device further performs a parameter calibration on one or more RF parameters for the plurality of channels in order to obtain the calibration data before scanning the plurality of channels, and stores the calibration data in the memory device directly or through the processor.

8. The communication device of claim 7, wherein the one or more RF parameters comprise a power parameter, a frequency parameter, an antenna parameter, and a receiver sensitivity parameter.

9. The communication device of claim 1, wherein the scanning radio device scans the plurality of channels while the primary radio device is providing the wireless communication service.

10. A communication device, comprising:
a processor;
a primary radio device, providing a wireless communication service to one or more client devices in a radio frequency (RF) environment and managing the wireless communication service in compliance with a predetermined wireless network protocol;
a scanning radio device, scanning a plurality of channels in one or more frequency bands provided in the RF environment in compliance with the predetermined wireless network protocol; and
a memory device, storing calibration data associated with the plurality of channels;
wherein the predetermined wireless network protocol is a Wi-Fi protocol;
wherein the primary radio device is a Wi-Fi access point (AP) chipset and the scanning radio device is a Wi-Fi client chipset;
wherein when scanning the plurality of channels, the scanning radio device switches to one of the plurality of channels according to the calibration data stored in the memory device.

11. The communication device of claim 10, wherein when scanning the plurality of channels, the scanning radio device further performs at least one of a plurality of operations comprising: determining a status of a channel utilization, determining a Received Signal Strength Indicator (RSSI) in a receiving direction, determining a noise level in the receiving direction, determining an RF spectrum, and determining channel state information associated with the plurality of channels.

12. The communication device of claim 10, wherein the scanning radio device further obtains one or more scanning results associated with the plurality of channels and provides the one or more scanning results to the processor or the primary radio device.

13. The communication device of claim 10, wherein the scanning radio device directly accesses the memory device to obtain the calibration data.

14. The communication device of claim 10, wherein the processor accesses the memory device to obtain the calibration data and forwards the calibration data to the scanning radio device.

15. The communication device of claim 10, wherein before scanning the plurality of channels, the scanning radio device further performs a parameter calibration on one or more RF parameters for the plurality of channels to obtain the calibration data.

16. The communication device of claim 15, wherein the one or more RF parameters comprise a power parameter, a frequency parameter, an antenna parameter and a receiver sensitivity parameter.

17. The communication device of claim 10, wherein the scanning radio device scans the plurality of channels while the primary radio device is providing the wireless communication service.
